(19) United States
(12) Patent Application Publication
(10) Pub. No.: US 2012/0227915 A1
(43) Pub. Date: Sep. 13, 2012

(54) GARAGE DOOR REINFORCEMENT BARRICADE

(76) Inventor: Matthew A. Rodriguez, Detroit, MI (US)

(21) Appl. No.: 13/225,834

(22) Filed: Sep. 6, 2011

Related U.S. Application Data
(60) Provisional application No. 61/464,813, filed on Mar. 10, 2011.

(51) Int. Cl. E05D 15/24; B23P 11/00; E05D 15/00

(52) U.S. Cl. 160/202; 160/209; 29/428

(57) ABSTRACT

A reinforcement barricade apparatus and method for bracing a garage door, which is formed of a plurality of panels connected to one another with hinged joints for opening and closing movement as a single unit, against inward movement of at least one of the plurality of panels adjacent guide rollers, which are connected to opposite ends of each panel, supported from guide tracks, which are installed along side portions of a garage structure adjacent to an opening extending through the garage structure. A supplemental stationary vertical support can extend from a floor of the garage structure adjacent each guide track along the side portions of the garage structure. A support bracket assembly mounted adjacent to opposite ends of each panel forming the garage door can be provided for sliding engagement with the supplemental stationary vertical support as the garage door moves between opened and closed positions.

### FIELD OF THE INVENTION

The invention relates to a device in the form of panel units made up of plural strips, slats, or panels interconnected for relative motion, and more particularly, a plurality of rigid strips, slats and/or panels interconnected with each other for relative motion and forming a single unit, where supplemental structure is provided to reinforce the track on which the panel units are mounted or supported to prevent undesired motion between the panels, where the structure holds the panels in a planar position and does not hold the panel units in any other position.

### BACKGROUND

Systems for bracing garage doors against hurricane force winds are generally known. See for example, U.S. Pat. No. 7,900,683; U.S. Pat. No. 7,891,401; U.S. Pat. No. 6,082,431; U.S. Pat. No. 5,964,269; and U.S. Pat. No. 5,620,038. Other garage door locking and/or reinforcement devices can be seen in U.S. Pat. No. 7,469,737; U.S. Pat. No. 7,438,114; U.S. Pat. No. 6,994,144; U.S. Pat. No. 6,796,361; U.S. Pat. No. 6,776,210; U.S. Pat. No. 5,967,216; U.S. Pat. No. 5,819,834; U.S. Pat. No. 5,706,877; U.S. Pat. No. 5,445,207; U.S. Pat. No. 5,383,509; U.S. Pub. Appl. No. 2007/0215294; and U.S. Pub. Appl. No. 2007/0151677. While these known devices appear suitable for their intended purpose, many of these devices disable the ability to continue to use the garage door in a customary fashion while the device is in place, others add significant weight to the moveable door structure making automatic door operation difficult or impossible, and some devices require complicated cable configurations or obstruct the garage door opening.

### SUMMARY

Typically, an intruder can separate a residential overhead garage door from one of the supporting guide tracks by forcing the roller pin to slide out of the guide track, thereby releasing support of the garage door panels from the tracks allowing entry into the garage. The tracks on a residential garage door are usually fairly easy to move out of the way, since the tracks are attached by a plurality of simple ninety degree sheet metal brackets. Once the roller pins are separated from the tracks, it is a simple process of shoving in the garage door, usually at the edge, to allow entry into the garage. It would be desirable to provide a garage door reinforcement system that did not add significant weight to the moveable garage door structure. It would be desirable to provide a garage door reinforcement system that did not significantly obstruct the garage door opening.

It would be desirable to provide a garage door reinforcement system that allowed continued use of the garage door in a customary fashion while the system was in place. It would be desirable to provide a garage door reinforcement system that would allow the use of an automatic garage door operator. It would be desirable to provide a garage door reinforcement system having sliding brackets attached to movable panels of the garage door cooperating with stationary columns adjacent each vertical guide track allowing the supplemental reinforcement column supports to be used on a daily basis without hindering the manual operation of the garage door, and without hindering the automatic operation of an optional automatic garage door opener. It would be desirable to provide a garage door reinforcement system that could be locked from the inside thereby preventing unauthorized entry through the garage door.

A garage door reinforcement barricade according to the invention can include a pair of supplemental stationary vertical column supports anchored to a floor of the garage. Each supplemental stationary vertical column support located adjacent to a corresponding vertical guide track portion supporting a sectional overhead garage door. Sliding brackets can be attached to a rear of the garage door sectional panel pieces to engage the supplemental supports automatically as the garage door travels along the guide track between the opened and closed positions. The supplemental supports and brackets can help prevent unauthorized entry into the garage as a result of an intruder pushing in on one or more of the sectional garage door panel pieces adjacent the track, while allowing the use of an optional automatic garage door opener.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of one end of a reinforcement barricade for a garage door formed of a plurality of panels connected to one another with hinged joints for movement as a single unit with guide rollers engaged within a guide track, the opposite end being a minor image thereof;

FIG. 2 is a detailed perspective view of the reinforcement barricade of FIG. 1 showing a supplemental stationary vertical support extending from a floor of the garage adjacent the guide track and support bracket assemblies connected adjacent to opposite ends of various panels forming the garage door for sliding engagement with the vertical support as the garage door moves between opened and closed positions;

FIG. 3 is an exploded detail view of an upper end of the vertical support of FIGS. 1 and 2, the vertical support having a cone shaped cap attached thereto, and each support bracket assembly having a guide block attached thereto for guided sliding engagement with respect to the vertical support, the support bracket assemblies transferring external forces applied to the panels of the garage door to the supplemental stationary vertical support to resist inward movement of the panels; and

FIG. 4 is detailed perspective view of a lower end of the vertical support of FIGS. 1-3, the vertical support having base plate anchored to a floor of the garage.

### DETAILED DESCRIPTION

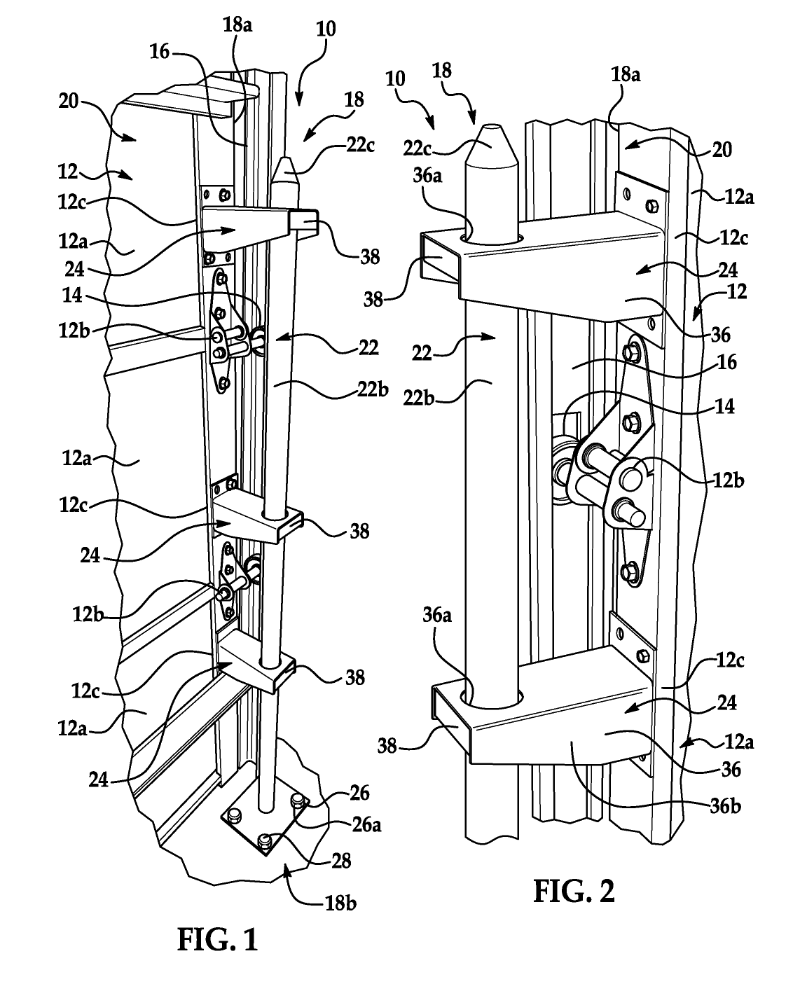

Referring now to FIGS. 1-4, a reinforcement barricade 10 for bracing an overhead garage door panel assembly 12, which is formed of a plurality of panels 12a connected to one another with hinged joints 12b for opening and closing movement as a single unit is illustrated. The reinforcement barricade 10 braces the garage door 12 against inward movement of at least one panel 12a adjacent guide rollers 14, which are connected to opposite ends of each panel 12a, supported from guide tracks 16, which are installed along side portions 18a of a garage structure 18 adjacent to an opening 20 extending through the garage structure 18. A supplemental stationary vertical support 22 extends from a floor 18b of the garage structure 18 adjacent the guide track 16 and support bracket assemblies 24 connected adjacent to opposite ends of each panel 12a forming the garage door 12 for sliding engagement with the vertical support 22 as the garage door 12 moves between opened and closed positions.

The reinforcement barricade 10 provides protection from burglary, where someone attempts to gain entry into a garage by attacking a panel style roll up garage door 12. The reinforcement barricade 10 can deter entry through the door opening 20 by bracing against inward movement of a panel due to inward force being applied by an intruder in an attempt to achieve removal or disengagement of the guide rollers 14 from the guide track 16 of the garage door 12. The reinforced barricade 10 is secured to the floor 18b by suitable hardware, by way of example and not limitation, such as a base plate 26 having a plurality of mounting apertures 26a for attachment to a concrete floor 18b by a plurality of mechanical fasteners 28. Depending on the garage structure 18 and weather conditions, different hardware can be used if desired. If the floor 18b is not level, some shimming may be necessary.

A lower extension portion 22a of the supplemental stationary vertical support 22 acts as a stabilizer bolt portion 22a, and extends below the concrete floor surface 18b. The lower extension portion 22a of the supplemental stationary vertical support 22 provides leverage against swaying or tearing from the base plate 26, since the stabilizer bolt 22a and the locking bolt 22b are a single piece of stainless steel welded to the base plate 26. An upper extension portion 22b, sometimes referred to herein as a locking bolt portion, of the supplemental stationary vertical support 22 engages a plurality of support bracket assemblies 24, sometime referred to herein as strike assemblies. By way of example and not limitation, three or four support bracket assemblies 24 can be provided. The number of support bracket assemblies is typically equal in number to two times the number of panels 12a to be supported, i.e. one support bracket assembly 24 on opposite ends of each panel 12a. A nose cone 22c can be connected to an upper end of the vertical support 22 for guiding engagement of the support bracket assemblies 24 in movement with respect to the vertical support 22.

The support bracket assemblies 24 can include a backer plate 30 having a plurality of apertures 30a formed therein, and a base 32 having a plurality of corresponding apertures 32a to be aligned coaxially with apertures formed in an inner flange edge portion 12c of the garage door 12 for receiving mechanical fasteners 34 therethrough. An inverted U-shaped bracket portion 36b of the strike body 36 can be attached to the base 32 to extend toward the vertical support 22 and can include a complementary aperture or periphery 36a for sliding engagement with the vertical support 22. A guide bushing 38 can be connected to the inverted U-shaped bracket portion 36b of the strike body 36 with an aperture 38a for guiding sliding engagement of the support bracket assembly 24 with respect to the vertical support 22.

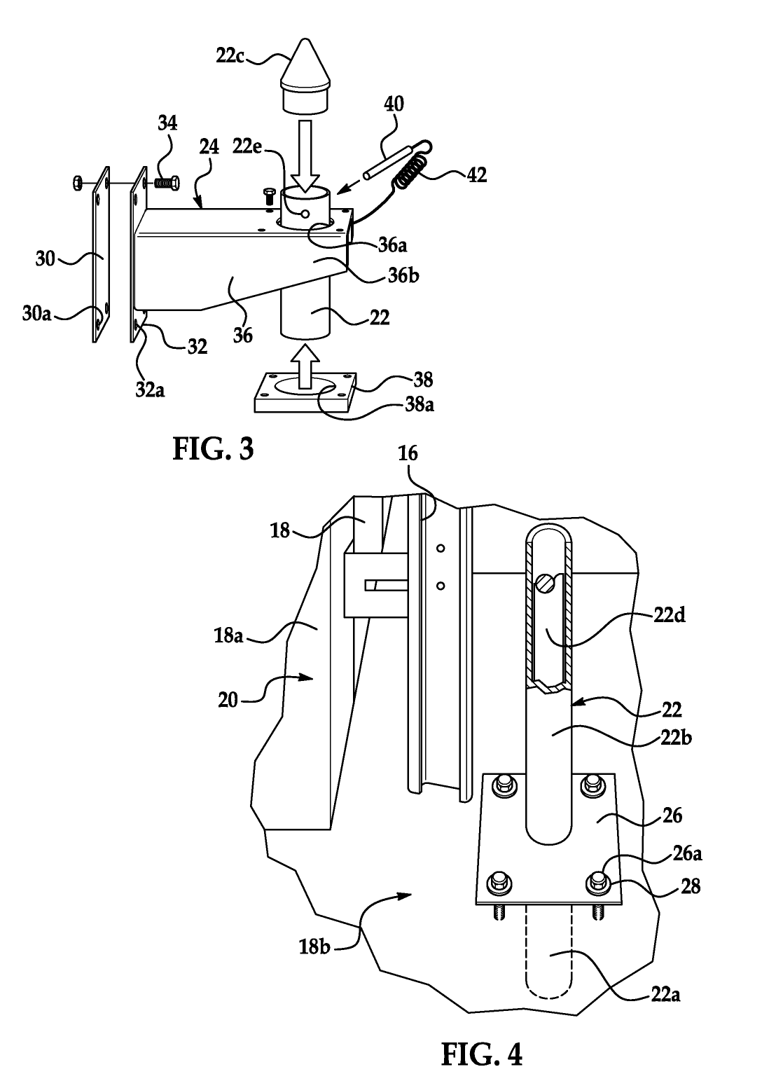

The nose cone 22c and guide bushing 38 can be formed of any suitable material, by way of example and not limitation, such as nylon, plastic, or wood, to reduce wear and tear on the contacting surfaces and/or to provide replaceable parts, if desired. The support bracket assembly 24 can be formed of a suitable material, by way of example and not limitation, such as stainless steel or other suitable strong metal or material. The vertical support 22 can be formed of any suitable material, by way of example and not limitation, such as stainless steel tube and sheet or other suitable strong metal or material. The vertical support 22 is illustrated with a circular cross-section, however it should be recognized that other cross-sectional shapes can be used without departing from the present disclosure. If desired, a durable flexible inner core 22d can be provided inside the vertical support 22 as best seen in FIG. 4. As best seen in FIG. 3, a locking pin 40 can be provided for engagement through apertures 22e formed in the vertical support 22 for locking the support bracket assemblies 24 in engagement with the vertical support 22. If desired, a pin-retaining tether 42 can be provided between the locking pin 40 and support bracket assembly 24 for retaining the pin 40 adjacent the support bracket assembly 24.

The support bracket assemblies 24 can be attached to the panels 12a by sandwiching an inner flange portion 12c of the garage door 12 between a backer plate 30 and a base 32 of the support bracket assembly 24. Once the support bracket assemblies 24 has been bolted through an inner flange edge portion 12c on opposite ends of each panel 12a to be supported, the reinforcement barricade 10 is operational and becomes part of the total structure of the overhead garage door panel assembly 12. The reinforcement barricade 10 provides support and anchorage to the garage door 12.

In operation, as the garage door 12 is raised and lowered, either manually or automatically, the locking bolt portion 22b of each vertical support 22 engages individual support bracket assemblies 24 on opposite ends of each panel 12a via guided engagement with the corresponding nose cones 22c on top of the vertical supports 22 located at opposite sides of the garage door opening as the nose cone 22c passes through the corresponding guide bushing 38 and through the complementary aperture 36a of the support bracket assembly 24. The complementary aperture 36a of the support bracket assembly 24 provides additional strength and resistance against inward movement of the garage door 12 with respect to the opening 20. In other words, the support bracket assembly 24 resists inward movement of a panel of the garage door to resist allowing the rollers 14 from being disengaged from the guide track 16 in response to inward force applied to the garage door panels 12a. Thereby providing increased security for the enclosed area of the garage structure 18. The reinforcement barricade 10 can be installed permanently allowing daily use without impeding the normal function of the garage door 12. The locking pin 40 can be engaged through the apertures 22e formed in the vertical support 22, by way of example and not limitation such as adjacent an upper end, to prevent opening movement, either manual or automatic, of the garage door 12, if desired. When normal function of the garage door 12 is again desired, the locking pin 40 can be removed from the apertures 22e allowing opening and closing movement, either manually or automatically, of the garage door 12.

A method of making a reinforcement barricade 10 for bracing a garage door 12, which is formed of a plurality of panels 12a connected to one another with hinged joints 12b for opening and closing movement as a single unit, against inward movement of at least one of the plurality of panels 12a adjacent guide rollers 14, which are connected at opposite ends to each panel 12a, supported from guide tracks 16, which are installed along side portions 18a of a garage structure 18 adjacent to an opening 20 extending through the garage structure 18, can include extending a supplemental stationary vertical support 22 from a floor 18b of the garage structure 18 adjacent each guide track 16 along the side portions 18a of the garage structure 18, and mounting a plurality of support bracket assemblies 24 with one support bracket assembly mounted adjacent to opposite ends of each panel 12a forming the garage door 12 for sliding engagement with the supplemental stationary vertical support 22 as the garage door 12 moves between opened and closed positions. The method can also include connecting a base plate 26 to the vertical support 22, and forming a plurality of apertures 26a in the base plate 26 for allowing passage of fasteners 28 therethrough to anchor the base plate 26 to the floor 18b of the garage structure 18. A lower stabilizer bolt portion 22a of the vertical support 22, located below the base plate 26, can be assembled to extend into the floor 18b of the garage structure 18 for additional resistance to movement of the vertical support 22 with respect to the floor 18b of the garage structure 18, wherein the base plate 26 divides the vertical support 22 into an upper locking bolt portion 22b and the lower stabilizer bolt portion 22a. A nose cone 22c can be connected to an upper end of the vertical support 22 for guiding the support bracket assemblies 24 in sliding engagement with respect to the vertical support 22. An inverted U-shaped bracket portion or strike body 36 can be formed having a complementary aperture 36a in sliding engagement with the vertical support 22. A base 32 can be provided having a plurality of apertures 32a for allowing passage of fasteners 34 for attachment of the strike body 36 to a panel 12a of the garage door 12. A backer plate 30 having a plurality of apertures 30a in coaxial alignment with respect to corresponding apertures 32a of the base 32 of the strike body 36 can be assembled allowing passage of fasteners 34 for attachment of the strike body 36 to the panel 12a of the garage door 12. A guide bushing 38 can be connected to the support bracket assemblies 24 to reduce wear and tear while engaged in sliding movement with respect to the vertical support 22.

A kit for assembling a reinforcement barricade 10 for bracing a garage door 12, which is formed of a plurality of panels 12a connected to one another with hinged joints 12b for opening and closing movement as a single unit, against inward movement of at least one of the plurality of panels 12a adjacent guide rollers 14, which are connected to opposite ends of each panel 12a, supported from guide tracks 16, which are installed along side portions 18a of a garage structure 18 adjacent to an opening 20 extending through the garage structure 18, can include a vertical support 22 to be assembled extending from a floor 18b of the garage structure 18 adjacent each guide track 16 along the side portions 18a of the garage structure 18. A plurality of support bracket assemblies 24, one support bracket assembly to be mounted adjacent to opposite ends of each panel 12a forming the garage door 12, can be assembled for sliding engagement with the vertical support 22 as the garage door 12 moves between opened and closed positions. A base plate 26 to be connected to the vertical support 22 and can have a plurality of mounting apertures 26a formed therein for allowing passage of fasteners 28 therethrough to anchor the base plate 26 to the floor 18b of the garage structure 18. The base plate 26 can divide the vertical support 22 into an upper locking bolt portion 22b and a lower stabilizer bolt portion 22a, wherein the lower stabilizer bolt portion 22a is to be installed extending below the base plate 26 and into the floor 18b of the garage structure 18 for additional resistance to movement of the vertical support 22 with respect to the floor 18b of the garage structure 18. A nose cone 22c can be connected to an upper end of the vertical support 22 for guiding the support bracket assemblies 24 in sliding engagement with respect to the vertical support 22. A bracket assembly portion or strike body 36 can have a complementary aperture 36a for sliding engagement with the vertical support 22 and a base 32 can have a plurality of apertures 32a for allowing passage of fasteners 34 for attachment of the strike body 36 to a panel 12a of the garage door 12. A backer plate 30 can have a plurality of apertures 30a to be positioned in coaxial alignment with respect to corresponding apertures 32a of the base 32 of the strike body 36 allowing passage of the fasteners 34 for attachment of the strike body 36 with an inner flange portion 12c of a panel 12a of the garage door 12 interposed between the backer plate 30 and the base 32 of the strike body 36. A guide bushing 38 can be connected to the support bracket assemblies 24 to reduce wear and tear while engaged in sliding movement with respect to the vertical support 22.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A reinforcement barricade (10) for bracing a garage door (12), which is formed of a plurality of panels (12a) connected to one another with hinged joints (12b) for opening and closing movement as a single unit, against inward movement of at least one of the plurality of panels (12a) adjacent guide rollers (14), which are connected to opposite ends of each panel (12a), supported from guide tracks (16), which are installed along side portions (18a) of a garage structure (18) adjacent to an opening (20) extending through the garage structure (18), the reinforcement barricade (10) comprising:
a supplemental stationary vertical support (22) extending from a floor (18b) of the garage structure (18) adjacent each guide track (16) along the side portions (18a) of the garage structure (18); and
a plurality of support bracket assemblies (24), one support bracket assembly (24) mounted adjacent to opposite ends of each panel (12a) forming the garage door (12) for sliding engagement with the supplemental stationary vertical support (22) as the garage door (12) moves between opened and closed positions.

2. The reinforcement barricade (10) of claim 1 further comprising:
a base plate (26) connected to the vertical support (22) having a plurality of apertures (26a) formed therein for allowing passage of fasteners (28) therethrough to anchor the base plate (26) to the floor (18b) of the garage structure (18).

3. The reinforcement barricade (10) of claim 2 further comprising:
the base plate (26) dividing the vertical support (22) into an upper locking bolt portion (22b) and a lower stabilizer bolt portion (22a), wherein the lower stabilizer bolt portion (22a) extends below the base plate (26) and into the floor (18b) of the garage structure (18) for additional resistance to movement of the vertical support (22) with respect to the floor (18b) of the garage structure (18).

4. The reinforcement barricade (10) of claim 1 further comprising:
a nose cone (22c) connected to an upper end of the vertical support (22) for guiding the support bracket assemblies (24) in sliding engagement with respect to the vertical support (22).

5. The reinforcement barricade (10) of claim 1, wherein the support bracket assemblies (24) further comprise:
a strike body (36) having a complementary aperture (36a) for sliding engagement with the vertical support (22) and a base (32) having a plurality of apertures (32a) for allowing passage of fasteners (34) for attachment of the strike body (36) to the panel (12a) of the garage door (12).

6. The reinforcement barricade (10) of claim 5 further comprising:
a backer plate (30) having a plurality of apertures (30a) in coaxial alignment with respect to corresponding apertures (32a) of the base (32) of the strike body (36) and for allowing passage of the fasteners (34) for attachment of the strike body (36) to the panel (12a) of the garage door (12) with an inner flange portion (12c) of the panel (12a) of the garage door (12) interposed between the backer plate (30) and the base (32) of the strike body (36).

7. The reinforcement barricade (10) of claim 1 further comprising:
a guide bushing (38) connected to the support bracket assemblies (24) to reduce wear and tear while engaged in sliding movement with respect to the vertical support (22).

8. A method of making a reinforcement barricade (10) for bracing a garage door (12), which is formed of a plurality of panels (12a) connected to one another with hinged joints (12b) for opening and closing movement as a single unit, against inward movement of at least one of the plurality of panels (12a) adjacent guide rollers (14), which are connected to opposite ends of each panel (12a), supported from guide tracks (16), which are installed along side portions (18a) of a garage structure (18) adjacent to an opening (20) extending through the garage structure (18), the method of making reinforcement barricade (10) comprising:
extending a supplemental stationary vertical support (22) from a floor (18b) of the garage structure (18) adjacent each guide track (16) along the side portions (18a) of the garage structure (18); and
mounting a plurality of support bracket assemblies (24) with one support bracket assembly (24) mounted adjacent to opposite ends of each panel (12a) forming the garage door (12) for sliding engagement with the supplemental stationary vertical support (22) as the garage door (12) moves between opened and closed positions.

9. The method of claim 8 further comprising:
connecting a base plate (26) to the vertical support (22); and
forming a plurality of apertures (26a) in the base plate (26) for allowing passage of fasteners (28) therethrough to anchor the base plate (26) to the floor (18b) of the garage structure (18).

10. The method of claim 9 further comprising:
extending a lower stabilizer bolt portion (22a) of the vertical support (22), located below the base plate (26), into the floor (18b) of the garage structure (18) for additional resistance to movement of the vertical support (22) with respect to the floor (18b) of the garage structure (18), wherein the base plate (26) divides the vertical support (22) into an upper locking bolt portion (22b) and the lower stabilizer bolt portion (22a).

11. The method of claim 8 further comprising:
connecting a nose cone (22c) to an upper end of the vertical support (22) for guiding the support bracket assemblies (24) in sliding engagement with respect to the vertical support (22).

12. The method of claim 8 further comprising:
engaging a strike body (36) having a complementary aperture (36a) in sliding engagement with the vertical support (22); and
providing a base (32) associated with the strike body (36) having a plurality of apertures (32a) for allowing passage of fasteners (34) for attachment of the strike body (36) to the panel (12a) of the garage door (12).

13. The method of claim 12 further comprising:
assembling a backer plate (30) having a plurality of apertures (30a) in coaxial alignment with respect to corresponding apertures (32a) of the base (32) of the strike body (36) allowing passage of the fasteners (34) for attachment of the strike body (36) to the panel (12a) of the garage door (12).

14. The method of claim 8 further comprising:
connecting a guide bushing (38) to the support bracket assemblies (24) to reduce wear and tear while engaged in sliding movement with respect to the vertical support (22).

15. A kit for assembling a reinforcement barricade (10) for bracing a garage door (12), which is formed of a plurality of panels (12a) connected to one another with hinged joints (12b) for opening and closing movement as a single unit, against inward movement of at least one of the plurality of panels (12a) adjacent guide rollers (14), which are connected to opposite ends of each panel (12a), supported from guide tracks (16), which are installed along side portions (18a) of a garage structure (18) adjacent to an opening (20) extending through the garage structure (18), the kit for assembling the reinforcement barricade (10) comprising:
a vertical support (22) to be assembled extending from a floor (18b) of the garage structure (18) adjacent each guide track (16) along the side portions (18a) of the garage structure (18); and
a plurality of support bracket assemblies (24), one support bracket assembly to be mounted adjacent to opposite ends of each panel (12a) forming the garage door (12), for sliding engagement with the vertical support (22) as the garage door (12) moves between opened and closed positions.

16. The kit of claim 15 further comprising:
a base plate (26) to be connected to the vertical support (22) having a plurality of apertures (26a) formed therein for allowing passage of fasteners (28) therethrough to anchor the base plate (26) to the floor (18b) of the garage structure (18).

17. The kit of claim 16 further comprising:
the base plate (26) dividing the vertical support (22) into an upper locking bolt portion (22b) and a lower stabilizer bolt portion (22a), the lower stabilizer bolt portion (22a) to be installed extending below the base plate (26) and into the floor (18b) of the garage structure (18) for additional resistance to movement of the vertical support (22) with respect to the floor (18b) of the garage structure (18).

18. The kit of claim 15 further comprising:
a nose cone (22c) to be connected to an upper end of the vertical support (22) for guiding the support bracket assemblies (24) in sliding engagement with respect to the vertical support (22).

19. The kit of claim 15 further comprising:
a strike body (36) having a complementary aperture (36a) for sliding engagement with the vertical support (22) and a base (32) having a plurality of apertures (32a) for allowing passage of fasteners (34) for attachment of the strike body (36) to the panel (12a) of the garage door (12); and
a backer plate (30) having a plurality of apertures (30a) to be positioned in coaxial alignment with respect to corresponding apertures (32a) of the base (32) of the strike body (36) for allowing passage of the fasteners (34) for attachment of the strike body (36) with an inner flange portion (12c) of a panel (12a) of the garage door (12) interposed between the backer plate (30) and the base (32) of the strike body (36).

20. The kit of claim 15 further comprising:
a base plate (26) connected to the vertical support (22) having a plurality of apertures (26a) formed therein for allowing passage of fasteners (28) therethrough to anchor the base plate (26) to the floor (18b) of the garage structure (18), the base plate (26) dividing the vertical support (22) into an upper locking bolt portion (22b) and a lower stabilizer bolt portion (22a), the lower stabilizer bolt portion (22a) to be extending below the base plate (26) and into the floor (18b) of the garage structure (18) for additional resistance to movement of the vertical support (22) with respect to the floor (18b) of the garage structure (18);
the support bracket assemblies (24) including a strike body (36) having a complementary aperture (26a) for sliding engagement with the vertical support (22) and a base (32) having a plurality of apertures (32a) for allowing passage of fasteners (34) for attachment of the strike body (36) to a panel (12a) of the garage door (12), and a backer plate (30) having a plurality of apertures (30a) in coaxial alignment with respect to corresponding apertures (32a) of the base (32) of the strike body (36) and for allowing passage of the fasteners (34) for attachment of the strike body (36) to the panel (12a) of the garage door (12) with an inner flange portion (12c) of the panel (12a) of the garage door (12) interposed between the backer plate (30) and the base (32) of the strike body (36);
a nose cone (22c) connected to an upper end of the vertical support (22) for guiding the support bracket assemblies (24) in sliding engagement with respect to the vertical support (22); and
a guide bushing (38) connected to each of the support bracket assemblies (24) to reduce wear and tear while engaged in sliding movement with respect to the vertical support (22).
